(19) United States
(12) Patent Application Publication
(10) Pub. No.: US 2026/0348882 A1
(43) Pub. Date: Nov. 5, 2026

(54) ELECTRON-BEAM DEFLECTION-BASED MULTI-EMISSION-POINT X-RAY COMPUTED TOMOGRAPHY APPARATUS AND METHOD

(71) Applicant: Scientific Gear Service Co., Ltd., Miaoli County (TW)

(72) Inventors: CHING-SHUN KU, Miaoli County (TW); CHIA-HSIEN LIN, Miaoli County (TW); BO-SHU TSAI, Miaoli County (TW); LIN-SHENG FU, Miaoli County (TW)

(21) Appl. No.: 19/662,230

(22) Filed: Apr. 29, 2026

Related U.S. Application Data
(60) Provisional application No. 63/798,056, filed on May 1, 2025.

(51) Int. Cl. G01N 23/046; G06T 12/20

(52) U.S. Cl. CPC G01N 23/046; G06T 12/20; G01N 2223/1016; G01N 2223/3308; G01N 2223/419; G01N 2223/6116; G06T 2211/412; G06T 2211/441

(57) ABSTRACT

An electron-beam deflection-based multi-emission-point X-ray computed tomography apparatus comprises a stage, a multi-angle X-ray generator, and at least one detector. The stage comprises a moving unit for carrying and moving a test object. The multi-angle X-ray generator dynamically forms X-ray emission points by an electron beam to respectively emit X-rays toward an imaging region of the stage from different directions, and the at least one detector respectively receives the X-rays emitted by the X-ray emission points. When a target region of the test object is moved to the imaging region by the moving unit, the X-rays emitted by the X-ray emission points pass through the target region, and the at least one detector receives the X-rays to obtain images of target region from different angles. The images of target region are used to reconstruct a three-dimensional tomography image of the target region.

### BACKGROUND OF THE INVENTION

### 1. Field of the invention

The present invention relates to an electron-beam deflection-based multi-emission-point X-ray computed tomography apparatus and method, and more particularly, to an electron-beam deflection-based multi-emission-point X-ray computed tomography apparatus and method capable of semiconductor inspection.

### 2. Description of the prior art

With the rapid advancement of technology, semiconductor devices have been widely adopted in consumer electronics, communication equipment, electric vehicles, artificial intelligence, and high-performance computing, and have become an indispensable core technology in various critical systems. With the continuous advancements in manufacturing processes, the structures of semiconductor devices are becoming increasingly complex. To maintain yield rates, effectively detecting internal structural defects in semiconductor devices and improving inspection efficiency have become critical issues in semiconductor manufacturing and quality control. In the prior art, an X-ray computed tomography (CT) system can be used to inspect the internal structures of semiconductor devices.

The X-ray tomography device of the prior art employs a configuration comprising a single X-ray emission point and a single two-dimensional detector. For flat semiconductor samples, there are two scanning methods: keeping the X-ray emission point stationary while simultaneously driving the semiconductor sample and the detector to perform corresponding circular motions, and capturing images at different positions; alternatively, the keeping the semiconductor sample stationary while simultaneously driving the X-ray emission point and detector to perform out-of-phase circular motions, and capturing images at different positions. In both of the above scanning methods, structural images of a single specific region within the semiconductor sample can be obtained from different angles at various positions. These structural images from different angles can be used to reconstruct a three-dimensional tomographic image of the specific region, and through this three-dimensional tomographic image, the structural defects at the specific region can be detected. However, at a time point, the X-ray tomography device of the prior art can only capture a single two-dimensional image of a specific region of the sample from a single specific angle. To obtain images from other specific angles, the sample scanning mechanism must drive the detector and the semiconductor sample or X-ray emission point to perform the aforementioned motions to move to different positions and then the images from other angles of the same specific region can be captured. To fully acquire the images of a single specific region of the semiconductor sample from multiple different angles, the above process must be repeated. The repeated waiting for the sample scanning mechanism to move and reposition significantly increases scanning time. Furthermore, in semiconductor inspection, a single semiconductor sample is not tested for just one specific region but for multiple regions, and the repeated movement and repositioning of the sample scanning mechanism described above will substantially increase inspection time and costs.

Therefore, there is an urgent need for a new type of X-ray tomography device to solve the above problem of the prior art.

### SUMMARY OF THE INVENTION

In view of this, the present invention provides an electron-beam deflection-based multi-emission-point X-ray computed tomography apparatus. According to an embodiment, the electron-beam deflection-based multi-emission-point X-ray computed tomography apparatus comprises: a stage comprising a moving unit to carry and drive a test object to move, and the stage having an imaging region; a multi-angle X-ray generator disposed on one side of the stage and comprising an electron beam emitter, an electron beam deflection module, and a X-ray generation target, wherein the electron beam emitter is configured to emit an electron beam, and the electron beam deflection module is configured to deflect a propagation direction of the electron beam so as to cause the electron beam to be incident at different positions on the X-ray generation target to dynamically form a plurality of X-ray emission points at the different positions of the X-ray generation target incident by the electron beam, thereby causing the X-ray emission points to emit X-rays from different directions toward the imaging region; and, at least one detector disposed on another side of the stage to receive the X-rays emitted by the X-ray emission points toward the imaging region. When the moving unit drives a target region of the test object to move into the imaging region, the X-rays emitted by the X-ray emission points pass through the target region of the test object, and the at least one detector receives the X-rays to obtain a plurality of images of target region from different angles.

The present invention also provides an electron-beam deflection-based multi-emission-point X-ray computed tomography apparatus. According to an embodiment, the electron-beam deflection-based multi-emission-point X-ray computed tomography apparatus comprises: a stage comprising a moving unit to carry and drive a test object to move, and the stage having an imaging region; a multi-angle X-ray generator disposed on one side of the stage and comprising an electron beam emitter, an electron beam deflection module, and a X-ray generation target, wherein the electron beam emitter is configured to emit an electron beam, and the electron beam deflection module is configured to deflect a propagation direction of the electron beam so as to cause the electron beam to be incident at different positions on the X-ray generation target to dynamically form a plurality of X-ray emission points at the different positions of the X-ray generation target incident by the electron beam, thereby causing the X-ray emission points to emit X-rays from different directions toward the imaging region; and, a plurality of detectors disposed on another side of the stage and respectively corresponding to the X-ray emission points, wherein the detectors are configured to receive the X-rays emitted by the X-ray emission points toward the imaging region. When the moving unit drives a target region of the test object to move into the imaging region, the X-rays emitted by the X-ray emission points pass through the target region of the test object, and the detectors respectively receive the X-rays to obtain a plurality of images of target region from different angles.

The present invention also provides an electron-beam deflection-based multi-emission-point X-ray computed tomography method. According to an embodiment, the electron-beam deflection-based multi-emission-point X-ray computed tomography apparatus comprises the following steps: placing a test object on a moving unit of a stage to move a target region of the test object into an imaging region of the stage; using a multi-angle X-ray generator to dynamically form a plurality of X-ray emission points by an electron beam to respectively emit X-rays from different directions toward the imaging region; and, using at least one detector to receive the X-rays passing through the imaging region and the target region of the test object from different directions to obtain a plurality of images of target region from different angles.

In summary, the electron-beam deflection-based multi-emission-point X-ray computed tomography apparatus and method of the present invention can emit multiple X-rays from multiple X-ray emission points at different angles toward a single target region of the test object. On the opposite side of the stage, a detector with multiple sub-detection surfaces or multiple detectors corresponding to the X-ray emission points receive the X-rays passing through the target region from different angles, so as to obtain images of target region from multiple angles, thereby reconstructing a three-dimensional tomographic image of the target region. Therefore, the target region need only be moved into the imaging region of the stage to obtain multiple two-dimensional images from multiple angles with a single positioning of the test object for reconstruction. Compared to the prior art, which requires movement and positioning before obtaining a two-dimensional image for each angle, it significantly reduces the overall imaging time. Furthermore, by deflecting the electron beam, a single X-ray generator can produce multiple X-ray emission points with different angles of emission, thereby reducing the manufacturing cost of the electron beam deflection-type multi-emission-point X-ray tomography apparatus. In summary, the electron beam deflection-type multi-emission-point X-ray tomography apparatus and method of the present invention significantly reduce inspection time and offer lower inspection costs.

### BRIEF DESCRIPTION OF THE APPENDED DRAWINGS

FIG. 1 is a schematic diagram illustrating an electron-beam deflection-based multi-emission-point X-ray tomography apparatus according to an embodiment of the present invention.

FIG. 2 is a schematic diagram illustrating the electron-beam deflection-based multi-emission-point X-ray tomography apparatus of FIG. 1 performing an inspection on a test object.

FIG. 3 is a schematic diagram illustrating the electron-beam deflection-based multi-emission-point X-ray tomography apparatus of FIG. 1 performing an inspection on the test object from another view angle.

FIG. 4 is a detailed schematic diagram illustrating the multi-angle X-ray generator of FIG. 1.

FIG. 5 is a schematic diagram illustrating an electron-beam deflection-based multi-emission-point X-ray tomography apparatus according to another embodiment of the present invention.

FIG. 6 is a schematic diagram illustrating the electron-beam deflection-based multi-emission-point X-ray tomography apparatus of FIG. 5 performing an inspection on the test object.

FIG. 7 is a schematic diagram illustrating the electron-beam deflection-based multi-emission-point X-ray tomography apparatus of FIG. 5 performing an inspection on the test object from another view angle.

FIG. 8 is a flowchart illustrating an electron-beam deflection-based multi-emission-point X-ray computed tomography method according to an embodiment of the present invention.

FIG. 9 is a flowchart illustrating an electron-beam deflection-based multi-emission-point X-ray computed tomography method according to another embodiment of the present invention.

FIG. 10 is a flowchart illustrating an electron-beam deflection-based multi-emission-point X-ray computed tomography method according to another embodiment of the present invention.

### DETAILED DESCRIPTION OF THE INVENTION

For the sake of the advantages and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the descriptions of this specification, the terms “an embodiment,” “another embodiment,” or “some embodiments” refer to at least one embodiment of the present invention that includes the specific features, structures, materials, or characteristics described in the embodiment. In this specification, the illustrative expressions of the above terms do not necessarily refer to the same embodiment. Furthermore, the specific features, structures, materials, or characteristics described may be combined in any one or more embodiments in an appropriate manner.

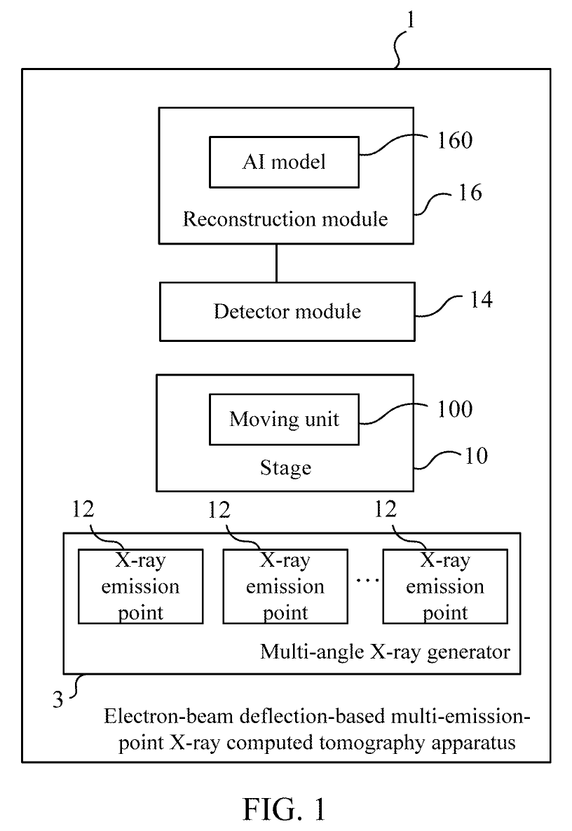

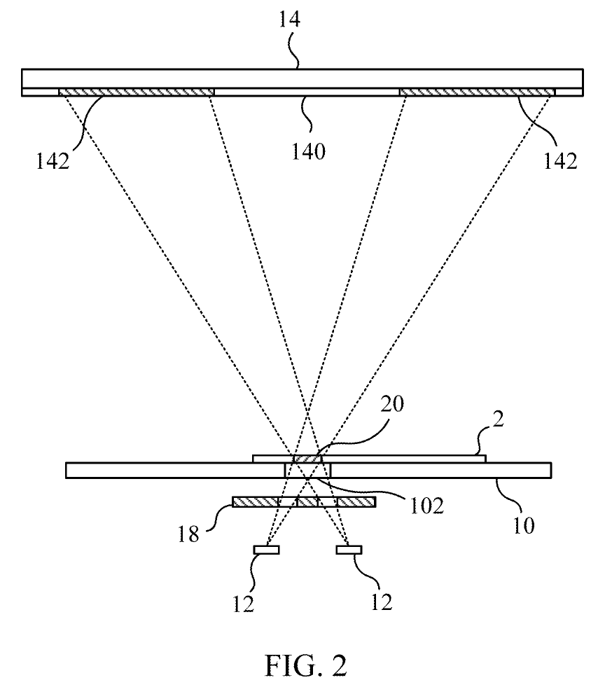

Please refer to FIGS. 1 and 2 together. FIG. 1 is a schematic diagram illustrating an electron-beam deflection-based multi-emission-point X-ray tomography apparatus 1 according to an embodiment of the present invention, and FIG. 2 is a schematic diagram illustrating the electron-beam deflection-based multi-emission-point X-ray tomography apparatus 1 of FIG. 1 performing an inspection on a test object 2. As shown in FIG. 1, the electron-beam deflection-based multi-emission-point X-ray tomography apparatus 1 of this embodiment comprises a stage 10, a multi-angle X-ray generator 3, and a detector module 14, wherein the multi-angle X-ray generator 3 comprises a plurality of X-ray emission points 12. Furthermore, as shown in FIG. 2, the multiple X-ray emission points 12 are arranged on one side of the stage 10, while the detector module 14 is arranged on the other side of the stage 10. The detector module 14 comprises at least one detector, and the least one detector has a detection surface 140, wherein the detection surface 140 can be divided into a plurality of sub-detection surfaces 142 by physical partitioning or by software-based partitioning, and the position of each sub-detection surface 142 is corresponding to the respective X-ray emission points 12. The stage 10 includes a moving unit 100 and an imaging region 102. The X-ray emission points 12 can emit X-rays toward the imaging region 102, and the X-rays can pass through the imaging region 102 to reach the sub-detection surfaces 142 of the detector module 14 to be received by each of the sub-detection surfaces 142. It should be noted that FIG. 2 is merely a two-dimensional side view of the electron-beam deflection-based multi-emission-point X-ray tomography apparatus 1. To show only two X-ray emission points 12 and the corresponding two sub-detection surfaces 142 as viewed from one side. However, in practice, the number of X-ray emission points 12 and sub-detection surfaces 142 is not limited to the two shown in FIG. 2, and their positions are not limited to the positions shown in FIG. 2.

In this embodiment, the stage 10 is used to support the test object 2, which is plate-shaped, and to move the test object 2 via a moving unit 100 (for the sake of simplicity, the moving unit is omitted in FIG. 2). In practice, the test object 2 may be, but not limited to, a semiconductor wafer. The moving unit 100 can move the target region 20 on the test object 2 to a position above the imaging region 102 of the stage 10. At this time, as shown in FIG. 2, the two X-ray emission points 12 can respectively emit X-rays from different directions toward the imaging region 102 of the stage 10, passing through the imaging region 102 and the target region 20 of the test object 2 located thereon. Subsequently, the corresponding sub-detection surfaces 142 on the detector module 14 respectively receive the X-rays from different directions and generate images of target region. These images of target region are two-dimensional images of the structure within the same target region 20 from different angles. Therefore, the moving unit 100 need only move the test object 2 once to obtain two-dimensional structural images of target region 20 from multiple angles.

Please refer again to FIG. 1. The electron-beam deflection-based multi-emission-point X-ray tomography apparatus 1 further comprises a reconstruction module 16 connected to the detector module 14. This module is capable of receiving the images of target region generated by the detector module 14 from different angles and reconstructing these two-dimensional structural images into a three-dimensional tomographic image of the structure within the target region 20, for subsequent determining whether there are defects in the structure within the target region 20. Furthermore, to prevent the X-rays emitted from each X-ray emission point 12 from spreading and affecting other parts of the test object 2, the electron-beam deflection-based multi-emission-point X-ray tomography apparatus 1 can further include a mask 18, as shown in FIG. 2. The mask 18 has multiple apertures corresponding to each of X-ray emission points 12 and the imaging region 102, allowing the X-rays emitted by each X-ray emission point 12 to pass only through the imaging region 102 and the target region 20 located thereon, while blocking other potentially diverging portions of the X-rays, thereby preventing the X-rays from affecting parts of the test object 2 other than the target region 20 which is currently imaged, so as to reduce the radiation dose to the test object 2.

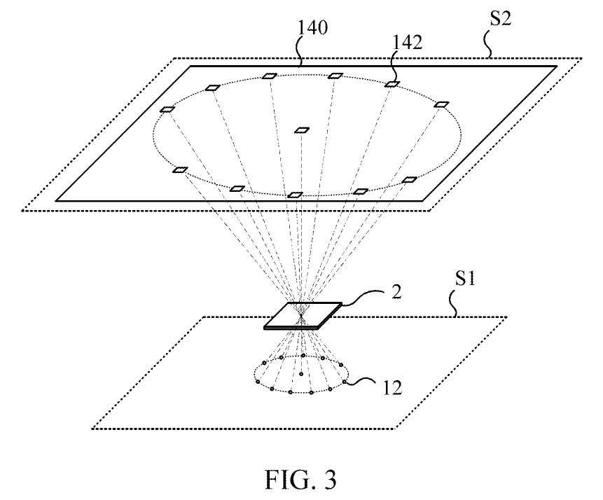

As described above, the number and the positions of the X-ray emission points 12 and the sub-detection surfaces 142 are not limited to those shown in FIG. 2. In practice, to obtain images of target region from multiple angles, the X-ray emission points 12 can be arranged in various directions, and the detection surface 140 of the detector module 14 can be divided into the corresponding sub-detection surfaces 142. Please refer to FIG. 3, which is a schematic diagram illustrating the electron-beam deflection-based multi-emission-point X-ray tomography apparatus 1 of FIG. 1 performing an inspection on the test object 2 from another view angle. It should be noted that, for the sake of simplicity, FIG. 3 omits the stage 10 and only shows the relative relationships between the X-ray emission points 12, the test object 2, and the detector module 14. As shown in FIG. 3, the number of X-ray emission points 12 can be 12, with 11 of X-ray emission points 12 arranged in a circular configuration and one X-ray emission point 12 positioned at the center of the ring. The number of sub-detection surfaces 142 is also 12, with 11 of the sub-detector surfaces 142 similarly arranged in a ring and one sub-detector surface 142 positioned at the center of the ring to receive X-rays emitted from the corresponding X-ray emission points 12. Thus, the moving unit 100 need only move the test object 2 once to obtain two-dimensional structural images of the target region 20 from 12 different angles. Similarly, the number of the X-ray emission points 12 and the sub-detection surfaces 142 is not limited to 12 as shown in FIG. 3. The arrangement of the X-ray emission points 12 and the sub-detection surfaces 142 is not limited to a circular arrangement, but can be determined according to the needs of the user or designer. For example, they can also be arranged in a linear, matrix, non-uniform configuration, or a combination of the aforementioned arrangements.

In this embodiment, the 12 X-ray emission points 12 are arranged in a circular configuration on a first plane S1, and the sub-detection surfaces 142 of the detector module 14 are arranged in a circular configuration on a second plane S2. The first plane S1 and the second plane S2 are parallel to each other and are also parallel to the test object 2. Due to the parallel arrangement, the ratios of the perpendicular distance from each X-ray emission point 12 to the test object 2 to the perpendicular distance from each X-ray emission point 12 to the corresponding sub-detection surface 142 are the same. Therefore, the images of target region captured at different angles by the sub-detection surfaces 142 have the same magnification and can be used to reconstruct the three-dimensional tomographic image without the need for magnification correction.

The function of the reconstruction module 16 to reconstruct the three-dimensional tomographic image from the two-dimensional images obtained at different angles can be achieved using artificial intelligence (AI). Please refer again to FIG. 1. In this embodiment, the reconstruction module 16 includes at least one AI model 160. The AI model 160 is used to perform denoising process on the images of target region to generate high-quality two-dimensional images, to perform sparse three-dimensional reconstruction process on the high-quality two-dimensional images to generate a full-view three-dimensional image, and to perform super-resolution process on the full-view three-dimensional image to generate a high-resolution three-dimensional tomographic image. In practice, the process by which the AI model 160 performs super-resolution processing on the full-view three-dimensional images to generate the high-resolution three-dimensional tomographic image may specifically involve re-slicing the full-view three-dimensional image into two-dimensional distribution images of multiple image layers to select the necessary image layers for super-resolution processing, and then generating the high-resolution three-dimensional tomographic image. Compared to performing super-resolution processing on all image layers, the above approach merely performing the super-resolution process on the necessary image layers can further reduce the computational load of the AI model to improve efficiency. However, in practice, whether to perform super-resolution processing on the full-view three-dimensional images can be adjusted according to user requirements. The training dataset used to train the AI model 160 includes datasets of long-exposure images and short-exposure images for different sample forms, datasets of large-angle images and small-angle images, and datasets of segmented and non-segmented images for the imaging region.

Since these training dataset includes both a large number of two-dimensional images from different angles of the same target region and the three-dimensional tomographic image reconstructed from them, as well as a small number of two-dimensional images from different angles and the three-dimensional tomographic image reconstructed from them, the trained AI model is capable of simulating the three-dimensional tomographic image reconstructed from a large number of two-dimensional images obtained at different angles using a small number of two-dimensional images obtained at different angles. Thereby, the electron-beam deflection-based multi-emission-point X-ray computed tomography apparatus 1 can achieve the effect of generating the high-resolution three-dimensional tomographic images by using a relatively small number of X-ray emission points 12 and sub-detection planes 142 (e.g., 12 X-ray emission points 12 and 12 sub-detection planes 142 as aforementioned), which would otherwise require a large number of X-ray emission points 12 and sub-detection planes 142.

Furthermore, the AI model 160 can include an artifact removal model for performing the super-resolution processing based on the full-view three-dimensional image to generate the high-resolution three-dimensional tomographic image. In other words, the artifact removal model can identify artifact structures based on the full-view three-dimensional image and removes the artifact structures to generate the high-resolution three-dimensional tomographic image. The artifact removal model is trained based on a machine learning algorithm by learning the corresponding relationships between a full-view three-dimensional image of a reference object, reconstructed from T two-dimensional images, and a high-resolution three-dimensional tomographic image, reconstructed from P two-dimensional images, where P > T. That is, the present invention can generate the high-resolution three-dimensional tomographic image from a small number of images of the test object using the artifact removal model to reduce the required number of the images and shorten the inspection time, thereby improving overall imaging efficiency and precision.

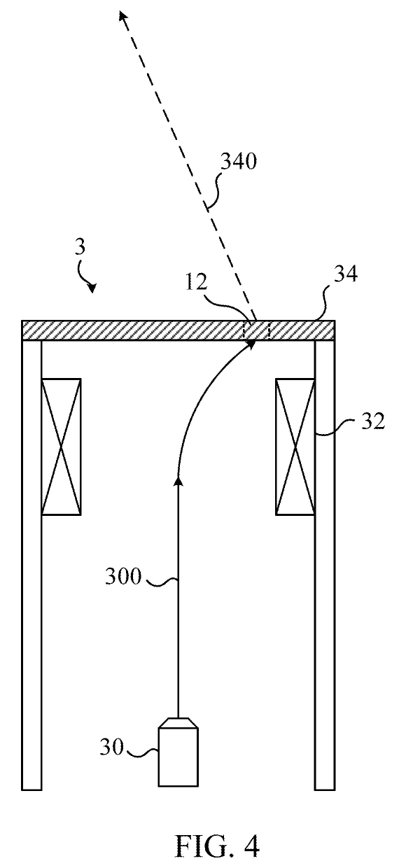

As shown in FIG. 1, in this embodiment, the plurality of X-ray emission points 12 located at different positions can be generated by a multi- angle X-ray generator 3. Please refer to FIG. 4. FIG. 4 is a detailed schematic diagram illustrating the multi-angle X-ray generator 3 of FIG. 1. In this embodiment, the multi-angle X-ray generator 3 can include an electron beam emitter 30, an electron beam deflection module 32, and an X-ray generation target 34. The electron beam emitter 30 emits an electron beam 300 toward the X-ray generation target 34, and after receiving the electron beam 300, the X-ray generation target 34 emits X-rays 340 outward from the opposite side of the reception point. The X-ray generation target 34 can be designed as a flat plate and can be located on the aforementioned first plane S1. In practice, the electron beam deflection module 32 can be a magnetic field generation module or an electromagnetic field generation module coupled to a controller, so that the electron beam deflection module 32 can be controlled to generate a magnetic field or an electromagnetic field within the multi-angle X-ray generator 3. When the electron beam deflection module 32 is not activated, the electron beam 300 emitted from the electron beam emitter 30 will be incident on the X-ray generation target 34 in a straight line. However, when the electron beam deflection module 32 is activated to generate a magnetic field or an electromagnetic field, the propagation direction of the electron beam 300 is deflected by the magnetic field or the electromagnetic field so that the electron beam 300 is incident on another position on the X-ray generation target 34, as shown in FIG. 4. By the controller controlling the electron beam deflection module 32 to generate the magnetic or electromagnetic fields, the positions at which the electron beam 300 is incident on the X-ray generation target 34 can be further controlled. These positions are corresponding to the aforementioned X-ray emission points 12, and it means that the X-ray emission points 12 are dynamically formed. For example, by generating 12 different magnetic or electromagnetic fields, the electron beam 300 can be directed to be incident at 12 positions arranged in a circular configuration on the X-ray generation target 34, thereby forming the 12 X-ray emission points 12 of the aforementioned embodiment. Furthermore, by adjusting the different magnetic or electromagnetic fields according to a programmable emission pattern, the number and positions of the X-ray emission points 12 can be controlled to obtain the images of target region with different number and different angles.

In this embodiment, the electron beam deflection module 32 of the multi-angle X-ray generator 3 can generate different magnetic fields or electromagnetic fields at different time points, causing the electron beam 300 emitted from the electron beam emitter 30 to be deflected in different directions at different time points and to be incident at different positions on the X-ray generation target 34 (i.e., the positions of the X-ray emission points 12), allowing the aforementioned multiple X-ray emission points 12 to emit X-rays at different times. In other words, at a time point, only the X-ray from a single direction passes through the target region 20 of the test object 2 to form the image of target region. However, the present invention is not limited to this. In practice, the multi-angle X-ray generator 3 can also include multiple electron beam emitters 30 in conjunction with one or more electron beam deflection modules 32. By utilizing multiple electron beams deflected by the magnetic or electromagnetic fields to be simultaneously incident at multiple different positions on the X-ray generation target 34, the aforementioned multiple X-ray emission points 12 can simultaneously emit X-rays passing through the target region 20 and form the images of the images of target region.

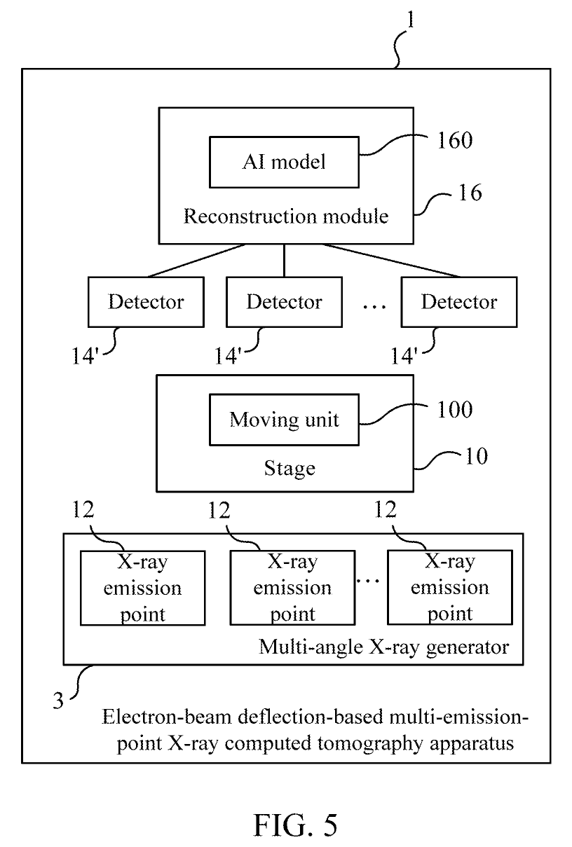

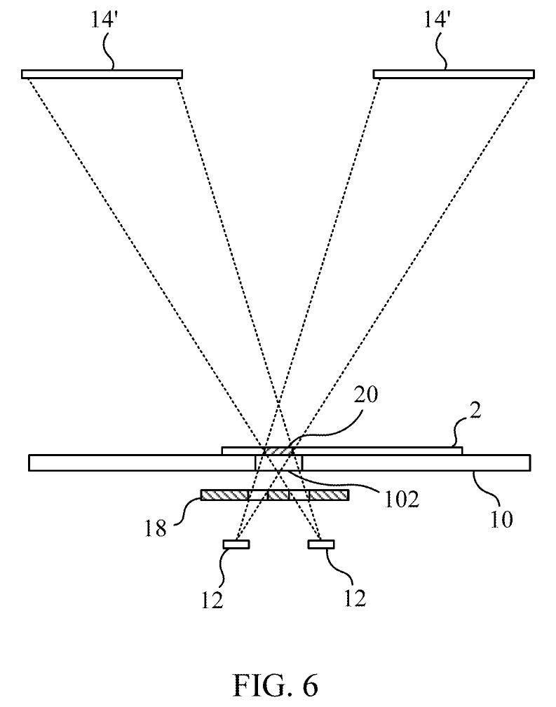

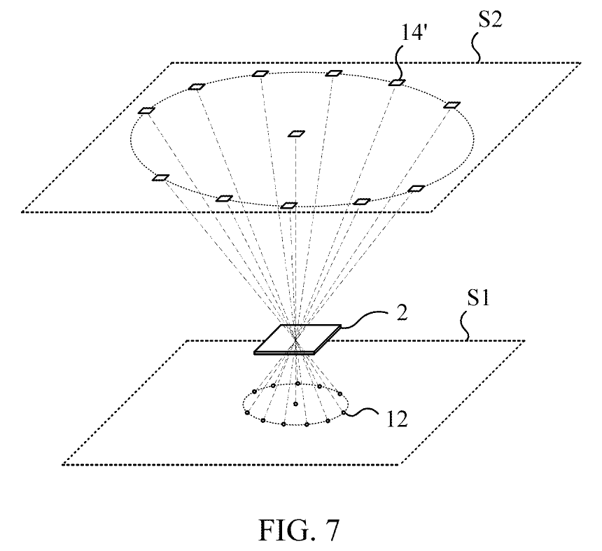

In the aforementioned embodiment, multiple sub-detection surfaces 142 of the detector module 14 respectively receive X-rays emitted from multiple X-ray emission points 12 in different directions. However, when the X-rays have a relatively large angle of incidence, the detector module can have multiple detectors used for imaging. Please refer to FIGS. 5-7. FIG. 5 is a schematic diagram illustrating an electron-beam deflection-based multi-emission-point X-ray tomography apparatus 1 according to another embodiment of the present invention. FIG. 6 is a schematic diagram illustrating the electron-beam deflection-based multi-emission-point X-ray tomography apparatus 1 of FIG. 5 performing an inspection on the test object 2. FIG. 7 is a schematic diagram illustrating the electron-beam deflection-based multi-emission-point X-ray tomography apparatus 1 of FIG. 5 performing an inspection on the test object 2 from another view angle. As shown in FIGS. 5-7, the difference between this embodiment and the aforementioned embodiment is that the detector module of the electron-beam deflection-based multi-emission-point X-ray tomography apparatus 1 in this embodiment comprises a plurality of detectors 14', and each of the detectors 14' is corresponding to the position of the corresponding X-ray emission point 12 and is configured to receive the X-ray emitted from the corresponding X-ray emission points 12. It should be noted that the other units of the electron-beam deflection-based multi-emission-point X-ray tomography apparatus 1 in this embodiment, including the multi-angle X-ray generator 3, are the same as the corresponding units in the aforementioned embodiment; therefore, they will not be repeated here. In practice, the detector module can include a single detector with multi-region or partition, multiple detectors, or time-multiplexed detection.

Wherein, each of the detectors 14' can also be arranged on the second plane S2, similar to the sub-detection planes 142 in the aforementioned embodiment. In other words, the ratios of the perpendicular distance from each X-ray emission point 12 to the test object 2 to the perpendicular distance from each X-ray emission point 12 to the corresponding detector 14' are the same. Therefore, the images of target region captured at different angles by the detectors 14' have the same magnification and can be used to reconstruct the three-dimensional tomographic image without the need for magnification correction.

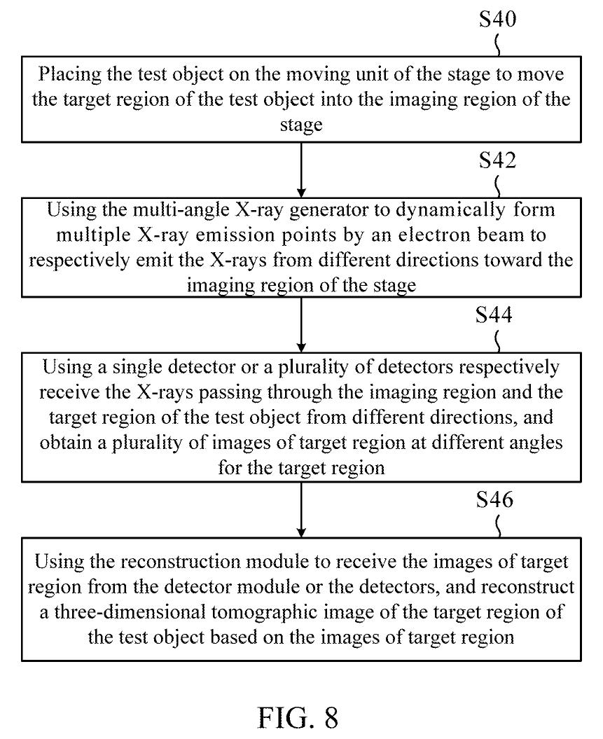

Please refer to FIG. 8. FIG. 8 is a flowchart illustrating an electron-beam deflection-based multi-emission-point X-ray computed tomography method according to an embodiment of the present invention. It should be noted that, the method of FIG. 8 can be achieved using the electron-beam deflection-based multi-emission-point X-ray tomography apparatus 1 of the aforementioned embodiment. Therefore, the steps of the electron-beam deflection-based multi-emission-point X-ray computed tomography method are described below with reference to the units of the electron-beam deflection-based multi-emission-point X-ray computed tomography apparatus 1.

As shown in FIG. 8, the electron-beam deflection-based multi-emission-point X-ray computed tomography method of this embodiment comprises the following steps: step S40: placing the test object 2 on the moving unit 100 of the stage 10 to move the target region 20 of the test object 2 into the imaging region 102 of the stage 10; step S42: using the multi-angle X-ray generator 3 to dynamically form multiple X-ray emission points 12 by an electron beam to respectively emit the X-rays from different directions toward the imaging region 102 of the stage 10; and, step S44: using a single detector (such as the aforementioned detection module 14 having multiple sub-detection surfaces 142) or the plurality of detectors 14' respectively receive the X-rays passing through the imaging region 102 and the target region 20 of the test object 2 from different directions, and obtain a plurality of images of target region at different angles for the target region 20. The images of target region obtained by the method of this embodiment are two-dimensional images, which can be used to reconstruct a three-dimensional tomographic image of the target region 20, thereby determining whether there are structural defects in the target region 20. Therefore, the method of this embodiment further includes step S46: using the reconstruction module 16 to receive the images of target region from the detector module 14 or the detectors 14', and reconstruct a three-dimensional tomographic image of the target region 20 of the test object 2 based on the images of target region. As described above, in step S44, the X-rays can be received and imaged by the detectors 14' respectively corresponding to the X-ray emission points 12, or by the sub-detection planes 142 divided from the detection module 14.

In practice, for a test object, particularly a semiconductor wafer, it may be necessary to inspect a plurality of target regions for structural defects to determine yield. For a plurality of target regions, the above steps of the method of this embodiment can be repeated to obtain the three-dimensional tomographic image of each target region. Thus, the inspection on each target region requires only a single movement and positioning to obtain the images from different angles, thereby significantly reducing the inspection time.

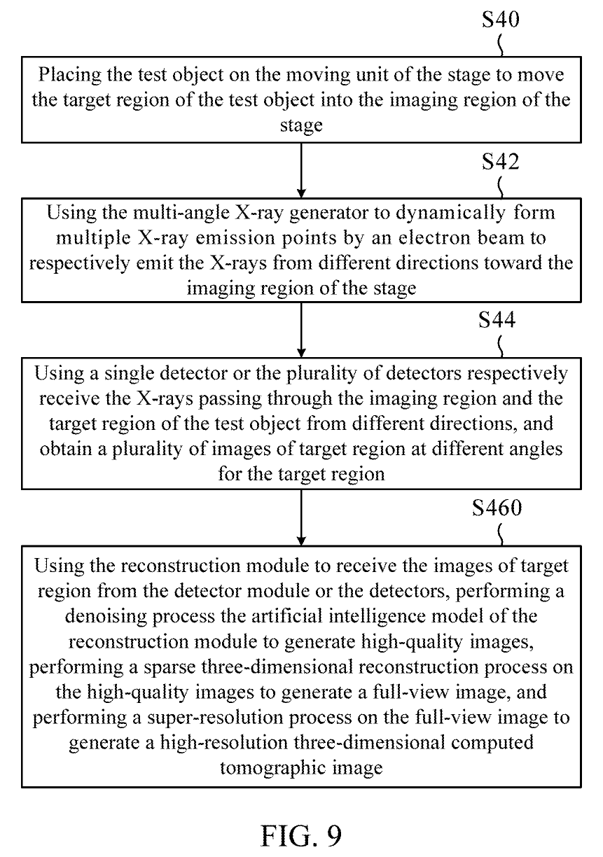

Similarly, the step of using the reconstruction module to reconstruct the three-dimensional tomographic image based on the two-dimensional structural images at multiple angles of the electron-beam deflection-based multi-emission-point X-ray computed tomography method of the present invention can also be achieved by the artificial intelligence module. Please refer to FIG. 9. FIG. 9 is a flowchart illustrating an electron-beam deflection-based multi-emission-point X-ray computed tomography method according to another embodiment of the present invention. As shown in FIG. 9, the difference between this embodiment and the previous embodiment is that the method of this embodiment includes step S460: using the reconstruction module 16 to receive the images of target region from the detector module 14 or the detectors 14', performing a denoising process the AI model 160 of the reconstruction module 16 to generate high-quality images, performing a sparse three-dimensional reconstruction process on the high-quality images to generate a full-view image, and performing a super-resolution process on the full-view image to generate a high-resolution three-dimensional computed tomographic image. It should be noted that the other steps of the method in this embodiment are substantially the same as the corresponding steps in the previous embodiments; therefore, they will not be repeated here.

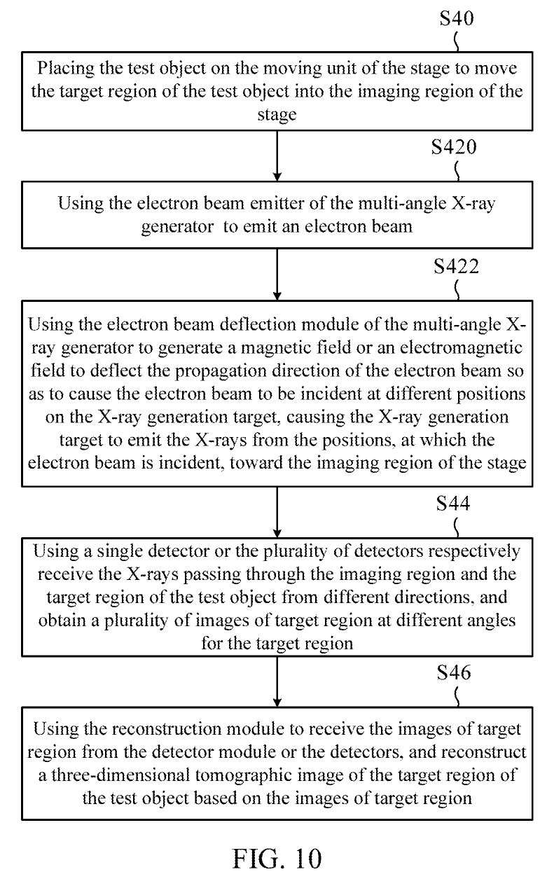

As described above, the plurality of X-ray emission points for detection can be generated by a single X-ray generator. Please refer to FIG. 10. FIG. 10 is a flowchart illustrating an electron-beam deflection-based multi-emission-point X-ray computed tomography method according to another embodiment of the present invention. As shown in FIG. 10, the difference between this embodiment and the previous embodiments is that the method of this embodiment further comprises the following steps: step S420: using the electron beam emitter 30 of the multi-angle X-ray generator 3 to emit an electron beam 300; and, step S422: using the electron beam deflection module 32 of the multi-angle X-ray generator 3 to generate a magnetic field or an electromagnetic field to deflect the propagation direction of the electron beam 300 so as to cause the electron beam to be incident at different positions on the X-ray generation target 34, thereby causing the X-ray generation target 34 to emit the X-rays from the positions, at which the electron beam 300 is incident, toward the imaging region 102 of the stage 10. The positions on the X-ray generation target 34 at which the electron beam 300, with the propagation direction deflected by the magnetic or electromagnetic field, is incident are the X-ray emission points 12 as aforementioned. Therefore, in step S422, changing the magnetic field or electromagnetic field at different time points causes the electron beam 300 to change its incident position, which in turn changes the position of the X-ray emission point 12, causing different X-ray emission points to emit X-rays at different time points. It should be noted that the other steps of the method in this embodiment are substantially the same as the corresponding steps in the previous embodiments; therefore, they will not be repeated here.

In summary, the electron-beam deflection-based multi-emission-point X-ray computed tomography apparatus and method of the present invention utilize multiple X-ray emission points in conjunction with multiple detectors to obtain a plurality of two-dimensional structural images from different angles within a single target region at a single movement and positioning of the test object on the stage, without rotating the test object, enabling the reconstruction of the three-dimensional tomographic image. It significantly reduces the total imaging time. Furthermore, by deflecting the electron beam, a single X-ray generator can produce multiple X-ray emission points with different angles of emission, thereby reducing manufacturing costs. Additionally, by utilizing the AI model, high-resolution three-dimensional tomographic images can be generated from a small number of two-dimensional images of the object obtained at different angles. This not only improves efficiency and image accuracy but also effectively reduces the number of X-ray emission points and detectors required for the three-dimensional tomographic image reconstruction.

With the examples and explanations mentioned above, the features and spirits of the present invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An electron-beam deflection-based multi-emission-point X-ray computed tomography apparatus, comprising:
a stage, comprising a moving unit, the moving unit being configured to carry and drive a test object to move, the stage having an imaging region;
an electron beam emitter, disposed at one side of the stage and configured to emit an electron beam;
an electron beam deflection module disposed at one side of the stage and configured to deflect a propagation direction of the electron beam;
an X-ray generation target, disposed at one side of the stage for the electron beam to be incident at different positions thereon to dynamically form a plurality of X-ray emission points at the different positions of the X-ray generation target incident by the electron beam, thereby causing the X-ray emission points to emit X-rays from different directions toward the imaging region; and
at least one detector, disposed on another side of the stage, the at least one detector being configured to receive the X-rays emitted by the X-ray emission points toward the imaging region;
wherein, when the moving unit drives a target region of the test object to move into the imaging region, the X-rays emitted by the X-ray emission points pass through the target region of the test object, and the at least one detector receives the X-rays to obtain a plurality of images of target region from different angles within a single positioning of the test object.

2. The electron-beam deflection-based multi-emission-point X-ray computed tomography apparatus of claim 1, wherein the X-ray emission points are arranged on a first plane on one side of the stage, and a detection surface of the at least one detector is configured on a second plane on another side of the stage, the first plane is parallel to the second plane.

3. The electron-beam deflection-based multi-emission-point X-ray computed tomography apparatus of claim 2, wherein the detection surface of the at least one detector is divided into a plurality of sub-detection surfaces by physical partitioning or by software-based partitioning, the sub-detection surfaces respectively receive the X-rays emitted by the X-ray emission points toward the imaging region to obtain the images of target region from different angles.

4. The electron-beam deflection-based multi-emission-point X-ray computed tomography apparatus of claim 1, further comprising a reconstruction module connected to the at least one detector, the reconstruction module being configured to receive the images of target region from the at least one detector and reconstruct a three-dimensional tomographic image of the target region of the test object based on the images of target region.

5. The electron-beam deflection-based multi-emission-point X-ray computed tomography apparatus of claim 4, wherein the reconstruction module comprises at least one artificial intelligence (AI) model, the at least one AI model is configured to perform a denoising process on the images of target region to generate high-quality two-dimensional images, perform a sparse three-dimensional reconstruction process on the high-quality two-dimensional images to generate a full-view three-dimensional image, and perform a super-resolution process by an artifact removal model on the full-view three-dimensional image to generate a high-resolution three-dimensional tomographic image, wherein a training dataset used for training the at least one AI model comprises datasets of long-exposure images and short-exposure images for different sample forms, datasets of large-angle images and small-angle images, and datasets of segmented and non-segmented images for the imaging region.

6. The electron-beam deflection-based multi-emission-point X-ray computed tomography apparatus of claim 1, wherein the electron beam deflection module is spatially, temporally or hybrid controlled by a controller to generates different magnetic fields or different electromagnetic fields at different time points so as to cause the electron beam to be incident at different positions of the X-ray emission points on the X-ray generation target at different time points, thereby causing the X-ray emission points to respectively emit the X-rays at different time points.

7. The electron-beam deflection-based multi-emission-point X-ray computed tomography apparatus of claim 1, wherein the at least one detector comprises a plurality of detectors configured to respectively receive the X-rays emitted by the X-ray emission points toward the imaging region and obtain the images of target region from fixed, adaptive, or programmable angles.

8. The electron-beam deflection-based multi-emission-point X-ray computed tomography apparatus of claim 7, wherein the X-ray emission points are arranged on a first plane on one side of the stage, and the detectors are arranged on a second plane on another side of the stage, the first plane is parallel to the second plane.

9. The electron-beam deflection-based multi-emission-point X-ray computed tomography apparatus of claim 1, wherein the X-ray emission points are arranged in at least one of a circular configuration, a linear configuration, a matrix configuration, and a non-uniform configuration.

10. An electron-beam deflection-based multi-emission-point X-ray computed tomography method, comprising the following steps:
placing a test object on a moving unit of a stage to move a target region of the test object into an imaging region of the stage;
using a multi-angle X-ray generator to dynamically form a plurality of X-ray emission points by an electron beam to respectively emit X-rays from different directions toward the imaging region; and
using at least one detector to receive the X-rays passing through the imaging region and the target region of the test object from different directions to obtain a plurality of images of target region from different angles within a single positioning of the test object.

11. The electron-beam deflection-based multi-emission-point X-ray computed tomography method of claim 10, wherein the X-ray emission points are arranged on a first plane on one side of the stage, and the at least one detector is arranged on a second plane on another side of the stage, the first plane is parallel to the second plane.

12. The electron-beam deflection-based multi-emission-point X-ray computed tomography method of claim 10, further comprising the following step:
using a reconstruction module to receive the images of target region from the at least one detector and reconstruct a three-dimensional tomographic image of the target region of the test object based on the images of target region

13. The electron-beam deflection-based multi-emission-point X-ray computed tomography method of claim 12, further comprising the following step:
using the reconstruction module to receive the images of target region generated by the at least one detector, performing a denoising process by at least one AI model of the reconstruction module to generate high-quality images, performing a sparse three-dimensional reconstruction process on the high-quality images to generate a full-view image, and performing a super-resolution process on the full-view image to generate a high-resolution three-dimensional computed tomographic image;
wherein, a training dataset used for training the at least one AI model comprises datasets of long-exposure images and short-exposure images for different sample forms, datasets of large-angle images and small-angle images, and datasets of segmented and non-segmented images for the imaging region.

14. The electron-beam deflection-based multi-emission-point X-ray computed tomography method of claim 10, further comprising the following steps:
using an electron beam emitter of the multi-angle X-ray generator to emit the electron beam; and
using an electron beam deflection module of the multi-angle X-ray generator to generate a magnetic field or an electromagnetic field to deflect a propagation direction of the electron beam so as to cause the electron beam to be incident at different positions of the X-ray emission points on the X-ray generation target, thereby causing the X-ray generation target to emit the X-rays from the positions, at which the electron beam is incident, toward the imaging region of the stage.

15. The electron-beam deflection-based multi-emission-point X-ray computed tomography method of claim 14, further comprising the following step:
using the electron beam deflection module to generate different magnetic fields or different electromagnetic fields at different time points, so as to cause the electron beam to be incident at different positions of the X-ray emission points on the X-ray generation target at different time points, thereby causing the X-ray emission points to respectively emit the X-rays at different time points.
